(19) United States
(12) Patent Application Publication
(10) Pub. No.: US 2014/0290439 A1
(43) Pub. Date: Oct. 2, 2014

(54) Canopy Tent Pole Mounted Bottle Opener

(71) Applicant: Daniel Chu West, (US)

(72) Inventors: Dallas Baxter Christian, Dublin, GA (US); Daniel Chu West, Brooklyn, NY (US)

(21) Appl. No.: 13/854,927

(22) Filed: Apr. 1, 2013

(51) Int. Cl. B67B 7/44

(52) U.S. Cl. CPC B67B 7/44
USPC 81/3.09

(57) ABSTRACT

The Canopy Tent Pole Mounted Bottle Opener (“Opener”) is a device that will be used for opening bottles and cans in conjunction with a canopy tent leg. While neither the canopy tent nor the canopy tent leg is a part of this patent application, the Opener is designed to be compatible and used in conjunction with several different types and brands of canopy tent legs that are already in the market. Using a simple, but effective design, the Opener can be attached to any of the canopy tent's collapsible legs and allow the user to pry open a bottle or can of his/her beverage of choice. The angle in which the Opener has been designed is unique and the only angle in which the proper amount of downward force may feasibly be applied to pry open a bottle without spilling the contents. Moreover, the protruding portion of the Opener can serve as a hook that may be used to hold a garbage bag to catch and collect discarded bottle caps. The hook may also serve several other functions such as a coat or hat rack as the user sees fit.

CROSS-REFERENCE TO RELATED APPLICATIONS

| Filing Date | Relationship of Application |
|---|---|
| Apr. 3, 2012 | Provisional Patent |

STATEMENT REGARDING FEDERALLY SPONSORED RESEARCH OR DEVELOPMENT

Not Applicable

### REFERENCE TO A MICROFICHE APPENDIX

Not Applicable

### SPECIFICATION

### BACKGROUND OF THE INVENTION

The Tent Leg Mounted Bottle Opener (“Opener”) is a device that will be used for opening bottles and cans in conjunction with a canopy tent leg. While neither the canopy tent nor the canopy tent leg are a part of this patent application, the Opener is designed to be compatible with several different types and brands of canopy tent legs that are already in the market and utilize the associated pushpin locking mechanism as described in this application. Using a simple, but effective design, the Opener will be attached to one of the canopy tent's collapsible legs and allow the user to pry open a bottle or can of his/her beverage of choice. The angle in which the Opener has been designed is unique and is the only angle in which there is enough available space for a bottle top to be inserted and allow the user to apply the proper amount of downward force to successfully and easily pry open a bottle without spilling. Moreover, the protruding top piece of the Opener has been specifically designed to freely hold a full garbage bag completely off the ground. Additionally, it may be used to hold any number of different objects such as apparel (coats, beach towels, hats, etc.), cooking utensils (spatula, tongs, etc.), or any other item(s) the user sees fit.

### BRIEF SUMMARY OF THE INVENTION

The object of the Opener is to provide a bottle/can opening device that can be connected to any of the four stationary legs of a collapsible canopy tent. The Opener will also, by its design, provide a hook on which to hang a garbage bag or anything else the user desires.

The Opener will consist of two main components, a hollow plastic cube with openings at the top and bottom (the “Housing”) and a flat, square piece of metal (the “Pry-Plate”) with two protruding pieces of metal: a longer curved piece (the “Pry-Bar”) and a shorter straight piece located below the Pry-Bar (the “Angle-Bar”). The entire component, including the Pry-Plate, Pry-Bar, and Angle-Bar shall be referred to collectively as the “Pry-Assembly”. The Pry-Assembly will have two holes bored into the top and bottom of it (the Pry-Assembly Connection Holes”) which will be used with the aid of two screws to secure the Pry-Plate to the Housing, forming the entire Opener. Once the Opener is fully assembled, a canopy tent leg will be inserted into the Housing's through-aperture and the Opener will slide onto the canopy tent leg and lock into place.

The four sides of the cubic Housing will be constructed using a solid and continuous piece of rigid material, most likely a form of plastic created from a plastic injected mold. The four sides of the Housing will each measure approximately 2.25 inches in height and 1.5 inches in width. The through-aperture running through the center of the Housing will measure approximately 1.25 inches×1.25 inches and allow a canopy tent leg to pass completely through it. Additionally, the two of the sides of the Housing will each contain two holes, strategically placed to allow the Opener to properly function. The first two holes shall be centered atop one another and located on one of the sides of the Housing (the “Locking Holes”). Each Locking Hole shall be precision cut to interact with and utilize the spring-loaded, internal pushpin locking system that is standard in a wide variety of canopy tent legs in the marketplace. The pushpin locking system of the canopy tent leg will fit within one of the Locking Holes and secure the Opener to the canopy tent leg. The dual Locking Holes will allow the user to adjust the height of the Opener to his/her liking. The Housing side adjacent to the Locking Holes side will contain the other two holes (the “Housing Connection Holes”). With the aid of two screws used with each respective Housing Connection Hole, the Pry Plate will be secured to the Housing.

### BRIEF DESCRIPTION OF THE SEVERAL VIEWS OF THE DRAWING

FIG. 1 is a side view of the Housing showing the through-aperture (9) and the two sides that are solid and contain no holes.

FIG. 2 is a side view of the Housing showing the two sides that contain the Locking Holes (1) and the Housing Connection Holes (2).

FIG. 3 is an inside view of the Housing showing how a screw (5) will be used in conjunction with one of the Housing Connection Holes (2) to secure the Pry-Assembly to the Housing and how the screw (5) will be counter sunk to allow it to sit flush inside the Housing.

FIG. 4 is a front view of the Pry-Assembly showing Pry-Plate (6) and depicting a front view of the Pry-Bar (3) and Angle-Bar (4).

FIG. 5 is a side view of the Pry-Assembly showing the Pry-Plate (6) and depicting a side view of the Pry-Bar (3) and Angle-Bar (4).

FIG. 6 is a perspective view depicting the Pry-Assembly being affixed to the Housing using the Housing Connection Holes (2), Pry-Assembly Connection Holes (10), and two flat-ended screws (5).

FIG. 7 is a perspective view of a supporting canopy tent pole leg (8), showing the Opener locked into place using the pushpin locking mechanism (7) of the supporting canopy tent's legs.

FIG. 8 is a magnified view of the Opener affixed to a supporting canopy tent pole leg (8) using the pushpin locking mechanism (7).

### DETAILED DESCRIPTION OF THE INVENTION

The present invention will now be described in detail, with reference to the drawings that supplement this application. It should be noted that the attached drawings represent only one of many possible embodiments of the invention and should not be limited to or understood to be the only possible embodiment of the invention.

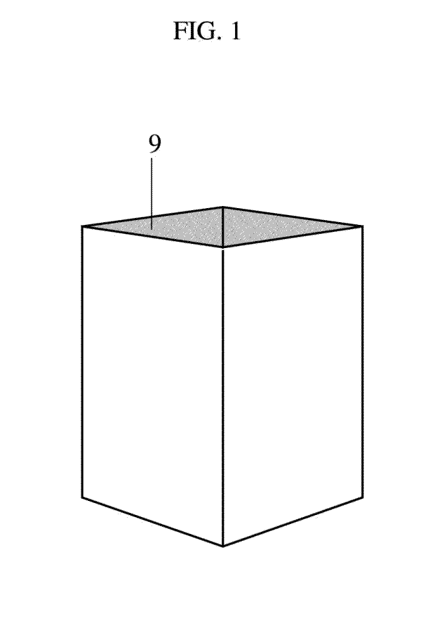

The use and assembly of the present invention will be described using FIGS. 1-8. As previously stated, the Opener is intended to be a bottle and can opener, which can be attached to a canopy tent leg and locked into place. The opener will fit on most of the square canopy tent legs in the marketplace and the approximate 140° angle of the Pry-Bar used in the Opener is only one that will successfully pry open a bottle top without spilling the contents thereof. While the major components of the Opener will most likely be composed of rigid plastic and metal, other suitable materials may similarly be used to exact the purposes herein. The object of the Opener is to provide a novel, pry-action component attached to a canopy tent's support pole that will remove the cap from a bottle when the bottle is inserted into the Opener and pivoted in a downward angle with respect thereto. The Opener will also, by its design through the Pry-Bar, provide a hook on which to hang and support a full garbage bag or anything else the user may desire.

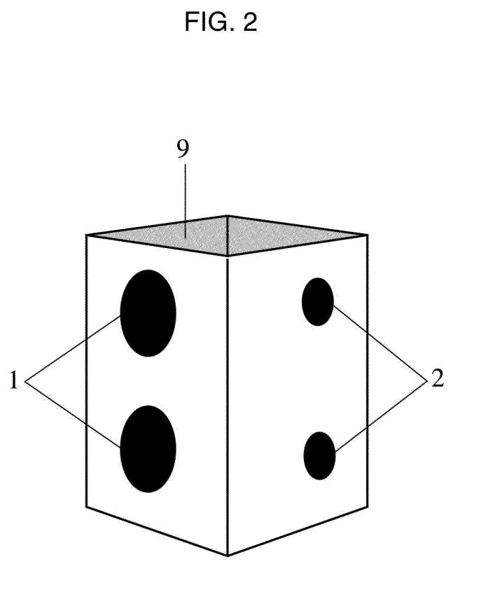

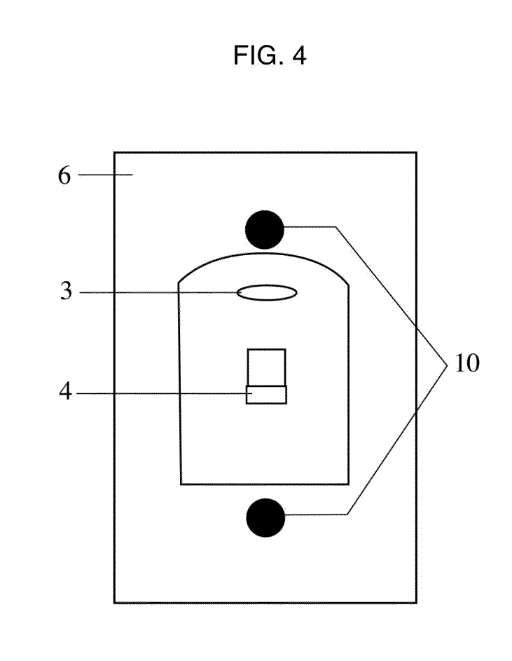

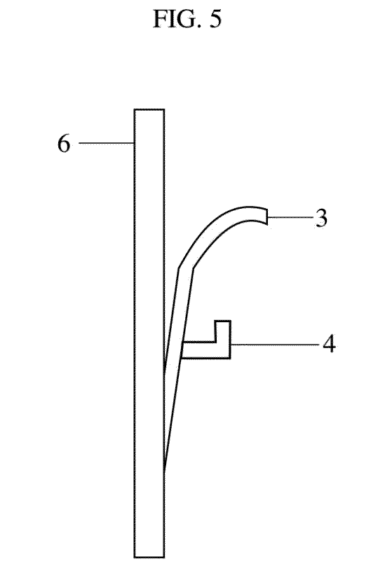

The Opener will consist of two main components, the Housing, depicted in FIGS. 1-3, and the Pry-Assembly, depicted in FIG. 4 and FIG. 5. As shown in FIGS. 1-2, the Housing will consist of four planar pieces of plastic, which have been injection molded into a single, solid and continuous piece of plastic. Each planar side of the Housing will have a depth/thickness of approximately 0.25 inches and will not have a top or bottom plane, thus create a through aperture (9), running the length of the Housing. Each of the four sides of the Housing will measure approximately 2.25 inches in height and 1.5 inches in width. The through aperture (9) created by the Housing will measure approximately 1.25 inches×1.25 inches. It should be noted that all Housing measurements are the inventors' best approximation based on the average size of canopy tent legs. Variations in the above mentioned measurements may be made by the inventor to fit differently sized canopy tent legs.

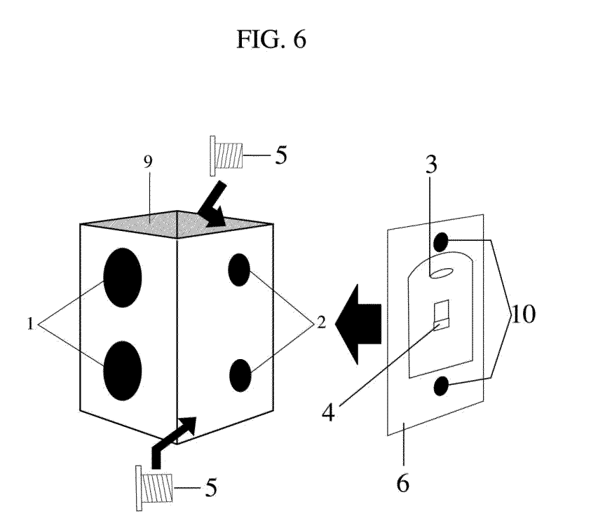

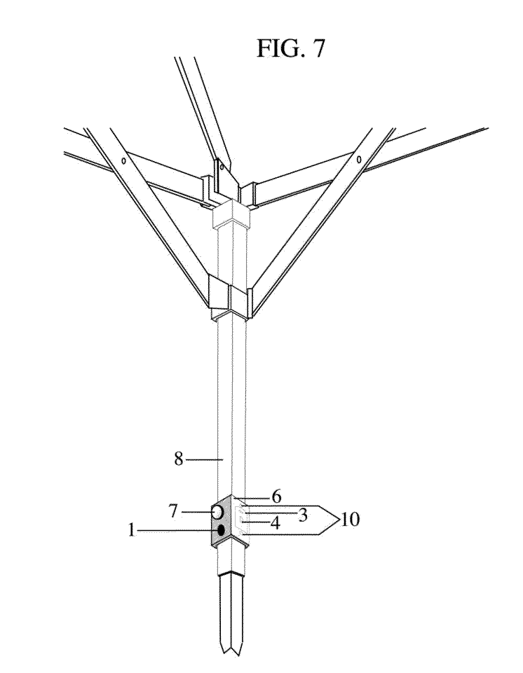

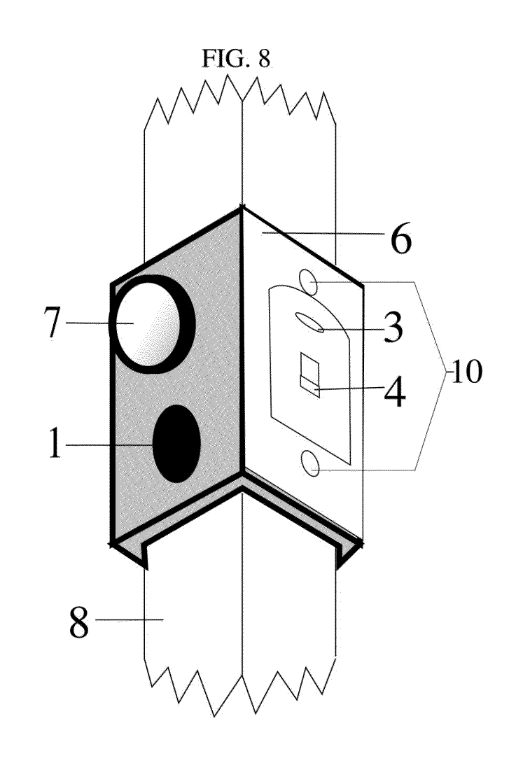

Two of the Housing's sides will have holes bored into them. FIG. 1. shows the two Housing sides which are solid and have no holes. FIG. 2. shows the two Locking Holes (1), which shall be centered atop one another and located about 0.25 inches from the respective top and bottom side of the Housing. The Locking Holes (1) shall be precision cut to utilize the spring-loaded, internal pushpin locking system (7), depicted in FIG. 6 and FIG. 8, and allow the pushpin to pass entirely, but tightly, through the Locking Holes (1) and affix the Opener to the canopy tent leg (8). The referenced pushpin locking mechanism (2) depicted in FIG. 7 and FIG. 8 is the standard connection mechanism used in the vast majority canopy tent legs in the marketplace. The pushpin locking mechanism (7) of the canopy tent leg, depicted in FIG. 8, will fit within one of the Locking Holes (1) and secure the Opener approximately 40.5 inches off the ground (which is a standard canopy tent leg connection length in the market place), enabling the user to utilize the bottle opener both in the standing and sitting positions. Moreover, the Locking Holes (1) will be identical in circumference and allow the user the ability to adjust the height of the Opener by choosing which Locking Hole (1) to engage the pushpin locking system (7).

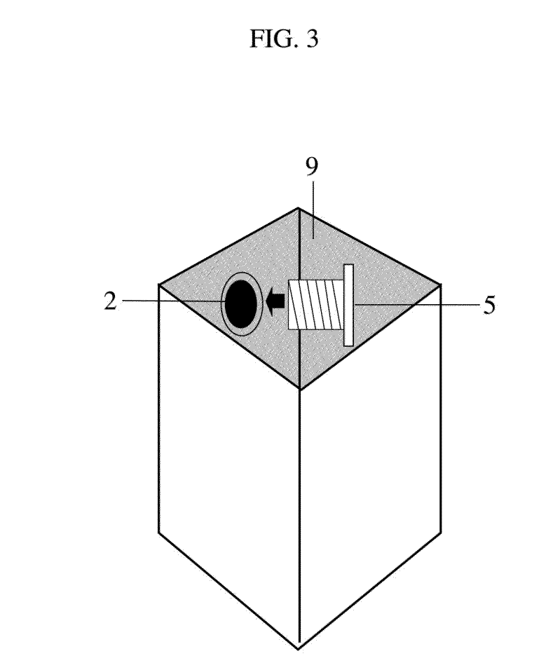

Also, as shown in FIG. 2, the Housing side adjacent to the Locking Holes (1) side of the Housing, will have two Housing Connection Holes (2) bored completely through it. The Housing Connection Holes (2) will be approximately 1.25 inches apart from one another. The interior edge of each Housing Connection Hole (2) will contain a slight depression, allowing the screw (5), approximately 8 mm diameter, pictured in FIG. 3, to fully pass through and be countersunk to sit flush with the inside of the Housing. The screws (5) must sit entirely flush with the Housing, to allow the Opener to slide freely along the canopy tent pole, as shown in FIG. 7.

The second component of the Opener is the Pry-Assembly, shown in FIGS. 4-5, which will be constructed of one entirely solid piece of metal, and serve as the bottle/can opener. As shown in FIGS. 4-5, the base of the Pry-Assembly, the Pry-Plate (6), will correspond with the length and width of one of the sides of the Housing. The Pry-Plate (6) will have two protruding pieces of metal: the longer, curved Pry-Bar (3) and the shorter, straight Angle-Bar (4) located below it. The Pry-Bar (3) extends upwards at an approximate 140° angle and is designed to slide over the top of a bottle cap when a user inserts one into the Opener. The angle of the Pry-Bar (3) has been specifically designed to allow a bottle top to be pried off, without spilling the contents of the bottle. The lip of the Pry-Bar (3) is also slightly beveled to allow it to slide beneath the flip-top of a can and pry open the top. The Pry-Bar (3) will also allow the user to hang a trash bag over it and keep the trash bag elevated above the ground. The Opener will continue to be utilized, even if the user hangs a trash bag over the Pry-Bar (3). The Angle-Bar (4) extends at an approximate 90° angle and is designed to fit under a bottle cap.

FIG. 4 shows that the Pry-Plate (6) contains two Pry-Assembly Connection Holes (10), which are identically sized and line up exactly with the Housing Connection Holes (2) found on the Housing, shown in FIG. 2. The inside of the Pry-Assembly Connection Holes (10) will be threaded to allow the screws (5), approximately 8 mm diameter, pictured in FIG. 3, to fully pass through and to tightly affix the Pry-Assembly (6) to the Housing. Specifically, and as shown in FIG. 6, the Pry-Assembly will be attached to the Housing when two flat-ended screws (5), approximately 0.25 inches long, are screwed through the Housing Connection Holes (2) of the Housing and the Pry-Assembly Connection Holes (10) of the Pry-Assembly (6). As previously noted and depicted in FIG. 3, the screws (5) will be screwed through both the Housing and the Pry-Assembly (6) from the interior of the Housing. The screws (5) will be countersunk and be completely flush with the Housing, allowing the canopy tent leg to be inserted into the through-aperture (9).

FIG. 7 demonstrates that once the Opener has been fully constructed, a canopy tent leg (8) may be inserted into the through aperture (9) located on the top and bottom of the Opener. The Opener will be able to slide freely up and down the canopy tent leg (8) until the user chooses to lock it into place, using the pushpin locking mechanism (7). The illustrated pushpin locking mechanism (7) is already a standard feature on many canopy tents and is currently used to lock all of the extendable legs of the canopy tent into place. When the user no longer desires to use the Opener, he may depress the pushpin locking mechanism (7) and slide the Opener up, down or completely detach it from the canopy tent leg (8).

FIG. 8 is a magnified view of FIG. 7 and shows how the Pry-Plate's (6) protruding Pry-Bar (3) is positioned at an approximately 140° angle and be positioned above and grip a bottle cap when the user inserts the bottle into the Opener. It also shows that beneath the Pry-Bar (3) is the Angle-Bar (4). When a bottle top is partially inserted into Opener, the Angle-Bar (4) shall be positioned directly underneath the bottle cap and the Pry-Bar (3) and Angle-Bar (4) will be used in conjunction to pry and remove a bottle's cap, when angular downward pressure is applied to the bottle by the user.

What is claimed is:

1. A bottle and can opener affixed to a supporting tent pole.
